(19) United States
(12) Patent Application Publication
(10) Pub. No.: US 2005/0081678 A1
(43) Pub. Date: Apr. 21, 2005

(54) Bicycle crank assembly

(76) Inventors: Garrett Andrew Smith, San Luis Obispo, CA (US); George Ernest Dubois, San Luis Obispo, CA (US)

Correspondence Address: Garett A. Smith, 1365 Bishop Street, San Luis Obispo, CA, 93401, US

(21) Appl. No.: 10/689,905

(22) Filed: Oct. 20, 2003

(51) Int. Cl. G05G 1/14

(52) U.S. Cl. 74/594.1

(57) ABSTRACT

A crank assembly comprises an axle with at least at one end thereof an engagement section, the engagement section comprising a central bore with a first inner threaded section. The engagement section is at least partially received in an opening in a crank arm. A bolt is inserted in the opening, comprising a first outer threaded section engaged with said first inner threaded section and a first tool-engaging hole. A stop element comprising a second outer threaded section and a second tool-engaging hole is inserted in said opening. The opening comprises a second inner threaded section engaged with the second outer threaded section. The second tool-engaging hole has a diameter larger than said first tool-engaging hole. The first tool-engaging hole is accessible from an axial direction through said second tool-engaging hole.

### TECHNICAL FIELD

The invention relates to the field of bicycles, and more particularly to a crank assembly and a method for mounting and dismounting a bicycle crank arm on an axle.

### BACKGROUND OF THE INVENTION

In known crank assemblies, a crank arm is mounted to an axle in a way that the two units can be separated in case they need to be exchanged or serviced. One known way of mounting a crank assembly on an axle is to provide a square engagement section at the axle ends. The square engagement section fits into a square opening of the crank arm. The engagement section comprises an inner thread, such that the crank arm can be fixed to the axle by means of a bolt.

In another known crank assembly, the engagement section does not have a square cross-section, but has a number of longitudinal splines. The crank arm opening has a number of corresponding grooves which receive the splines when the engagement section is received in the opening. Some embodiments of this engagement type further comprise an inner thread, such that the crank arm can be fixed to the axle by means of a bolt.

In both configurations, the problem arises that the axle and crank are in such tight engagement that they cannot easily be separated when attempting to dismount the crank. Specialized tools have been developed to separate the crank from the axle but these tools are quite heavy and suited strictly for shop use.

This problem has been solved by providing a bolt with an outer threaded section engageable with the engagement section. The bolt serves to hold the crank arm and the axle together. If an axial stop is provided at the crank arm, unscrewing of the bolt leads to automatic separation of the engagement section from the opening. A construction of the above-mentioned type is described in EP 0 909 699.

Here, a stop ring is inserted in the opening and axially fixed. In another embodiment, an integrated member of the crank arm provides the function of the stop ring. The present invention aims to provide a crank assembly and a method for dismounting a crank arm from an axle which are easy in construction and do not make use of special tools.

### SUMMARY OF THE INVENTION

The crank assembly according to the invention has an engagement section of an axle mounted in an opening of a crank arm. A bolt is screwed into the engagement section. A stop element is screwed into the opening. The bolt has a first tool-engaging hole, for example a multi-sided hole of hexagonal cross-section, in which an Allen key can be inserted to turn the bolt. The stop element has a second tool-engaging hole of larger diameter. The first tool-engaging hole is accessible from the outside in an axial direction through the second tool engaging hole.

This assembly is easy to mount and dismount. The stop element is simply screwed into the crank opening with a tool corresponding to the second tool-engaging hole, e.g. an Allen key. A tool of smaller diameter can be inserted through the second tool-engaging hole into the first tool-engaging hole to turn the bolt. No special tools are required to install or remove the stop element, the bolt, or the crank arm.

Numerous other benefits and advantages will become apparent from the following detailed description of the preferred embodiment of the invention with reference to the drawings.

### BRIEF DESCRIPTION OF THE DRAWINGS

FIG. 1 shows an axial cross-section through a bottom bracket of a bicycle;

FIG. 2 shows a perspective exploded view of a crank arm, a bolt and a stop element;

FIGS. 3a and 3b show a perspective view and an axial cross section of a bolt;

FIGS. 4a and 4b show a perspective view and axial cross section of a stop element;

FIG. 5 shows, partly in cross-section, an exploded view of elements of a crank assembly;

FIGS. 6a-6c show, partly in cross-section, different stages of dismounting a crank arm from an axle;

FIG. 7 shows a bicycle comprising a crank assembly of the present invention.

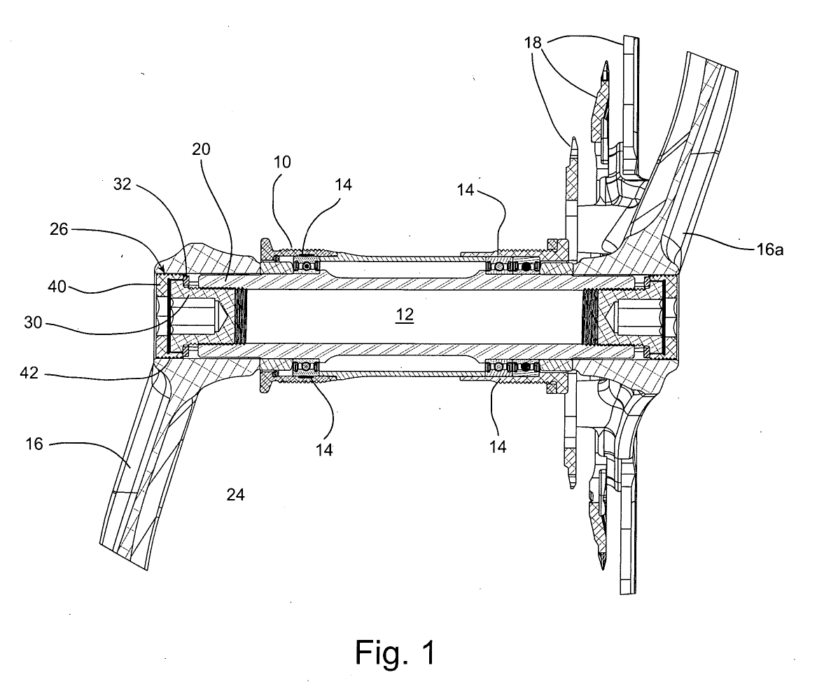

FIG. 1 shows a bottom bracket assembly of a bicycle. In a bottom bracket sleeve 10, an axle 12 is mounted on bearings 14. Crank arms 16, 16a are mounted on the axle 12. On both crank arms, pedals are mounted (not shown). One crank arm 16a has sprockets 18 attached.

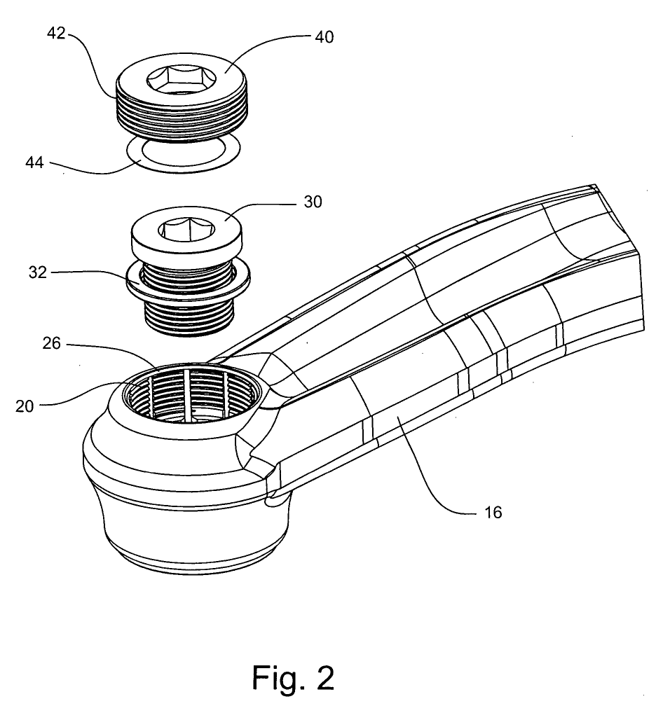

As can also be seen from FIG. 2, crank arm 16 comprises an opening 20 at one end. An end of axle 12, which is configured as an engagement section 22, is received in the opening 20. The engagement section 22 comprises a central bore with an inner thread 24. A bolt 30 is screwed into the thread 24. On top of bolt 30, a stop element 40 comprising an outer thread 42 is screwed into an inner thread 26 of the opening 20. A friction-reducing washer 44, in this embodiment made from PTFE plastic, is interposed between stop element 40 and bolt 30. Further, a metal washer element 32 is provided in the opening 20.

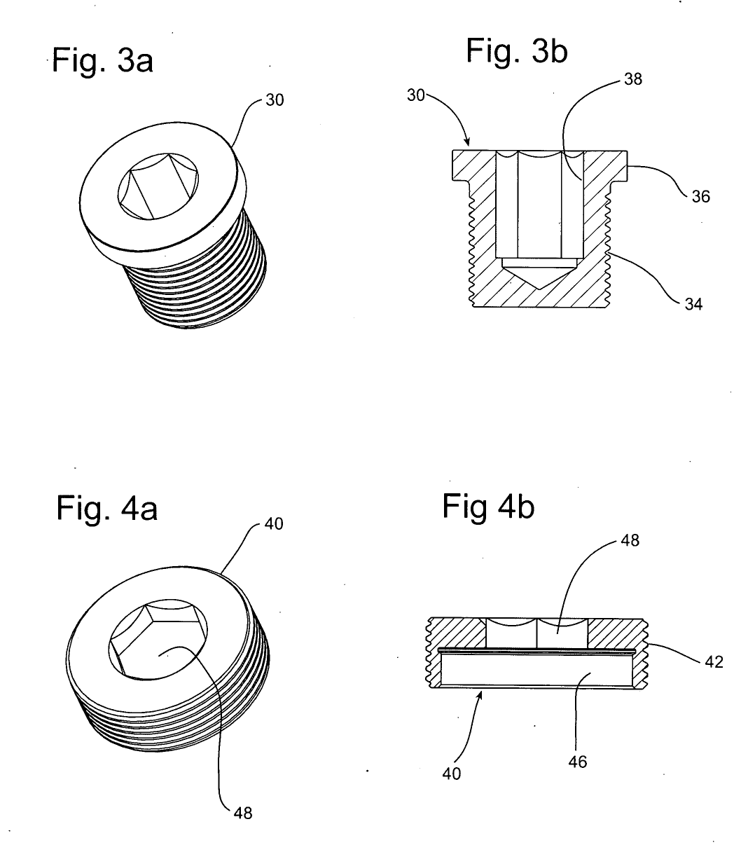

FIGS. 3a and 3b show the bolt 30. Bolt 30 includes a threaded section 34. At the upper end of bolt 30, a flange 36 is provided, extending in diameter larger than the threaded section 34. Bolt 30 comprises a multi-sided hole 38 of hexagonal cross-section. Alternatively, hole 38 may be shaped in any way such that a tool engaged with hole 38 is non-rotatably coupled to bolt 30. Hole 38 extends from flange 36 axially into the threaded section 34. Though not shown, in an alternative embodiment hole 38 may traverse bolt 30 entirely.

FIGS. 4a and 4b show stop element 40. Stop element 40 has the general shape of a disk with thread 42 provided as the circumference. An axial recess 46 is provided on one side of stop element 40, which can receive flange 36 of bolt 30.

Further, a tool-engaging hole 48 traverses stop element 40. Tool-engaging hole 48 is of hexagonal cross-section and has a larger diameter than tool-engaging hole 38 of bolt 30. Alternatively, tool-engaging hole 48 may be of any shape such that a tool may be non-rotatably coupled to stop element 40.

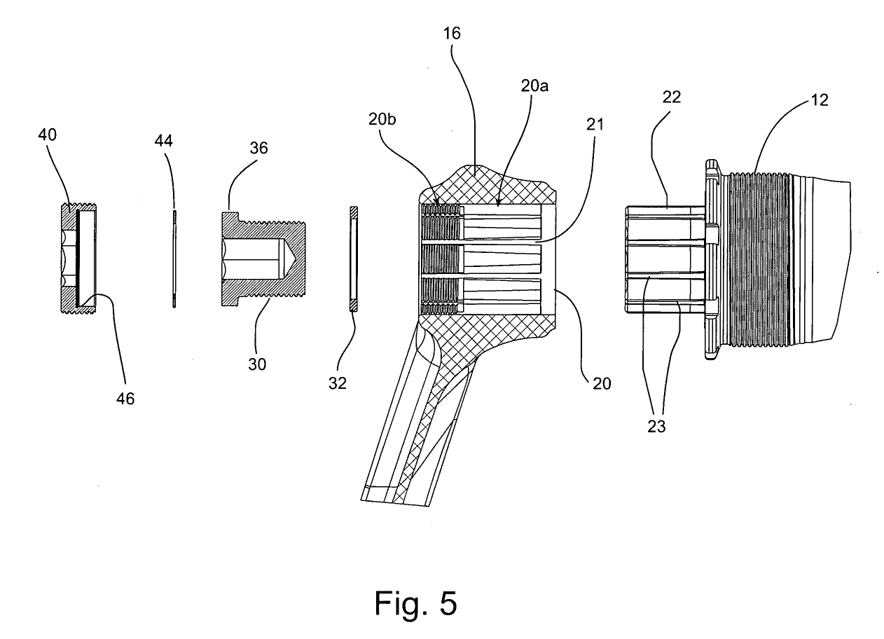

FIG. 5 shows in an exploded view how the different parts are put together, so that the assembly of FIG. 1 is formed. The opening 20 of the crank 16 is axially divided into two portions. A first portion 20a has longitudinal grooves provided on the inside. A second portion 20b has an inner thread provided on the inside. Engagement section 22 of axle 12 comprises longitudinal splines 23, which fit into the grooves 21 when crank 16 is mounted on the axle 12.

Crank 16 is fixed to axle 12 by bolt 30 and washer 32, which are inserted into the opening 20. Washer 32 abuts against the upper edges of longitudinal grooves 21. Bolt 30 is screwed into engagement section 22, whereby flange 36 together with washer 32 fixes the connection between crank arm 16 and axle 12 when it is screwed in using a tool such as an Allen key inserted into hole 38. Splines 23 inserted in the grooves 21 form a very tight, non-rotatable connection between crank 16 and axle 12. A friction-reducing washer 44 is inserted on top of bolt 30. Finally, stop element 40 is screwed into thread 26 of opening 20 until washer 44 and flange 36 of bolt 30 are received in its recess 46. A tool such as an Allen key inserted into tool-engaging hole 48 is used to install stop element 40 tightly into thread 26.

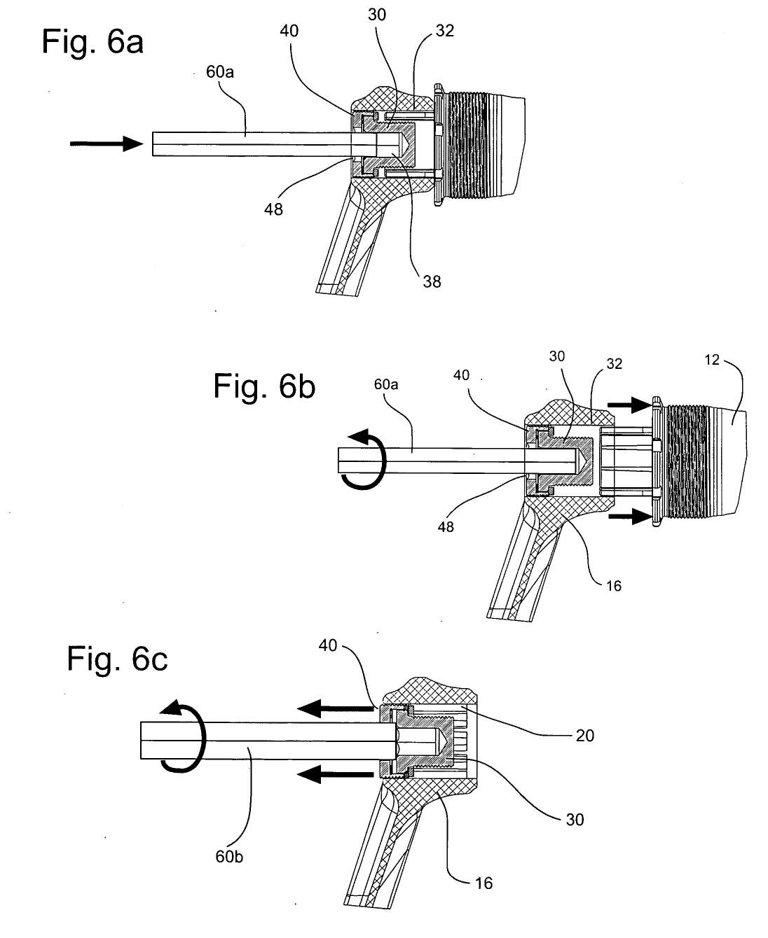

FIGS. 6a-6c show how the assembly is dismounted. First, a tool such as an Allen key 60a fitting into tool-engaging hole 38 of bolt 30 is inserted through hole 48 of stop element 40. Because of the larger diameter of hole 48, Allen key 60a can be turned freely within hole 48 without turning stop element 40. When the tool 60a is turned to unscrew bolt 30 from engagement section 32, this leads to axial movement of the axle 12 as indicated by arrows in FIG. 6b. Bolt 30 is axially stopped at the left side in FIG. 6b by stop element 40, so that unscrewing bolt 30 leads to separation of engagement section 32 and opening 20, i.e. between splines 23 and grooves 21. The friction-reducing washer 44 provided between the stop element 40 and bolt 30 serves to minimize friction, such that stop element 40 does not turn with bolt 30.

Thus, crank 16 can be taken off axle 12 and tool 60a can be removed.

Though described in the preferred embodiment, it is possible to eliminate the friction-reducing washer 44 providing the frictional force between the bolt 30 and stop element 40 is sufficiently low that stop element 40 does not rotate as bolt 30 is unscrewed. Such may be the case if lubrication is used between the bolt 30 and stop element 40 or either the bolt 30 or stop element 40 is coated with friction-reducing material, such as a PTFE coating.

Bolt 30 and stop element 40 can be made sufficiently lightweight through the use of lightweight metallic materials such that the combination of bolt 30 and stop element 40 can be left permanently installed into crank 16, 16a. Thus it is always possible for the bicycle rider to install or remove cranks 16, 16a from bottom bracket axle 12 without special tools. The only tool required is tool 60a, such as an Allen key, which is typically carried by riders to service other parts of their bicycle. However, if required, a second tool 60b, again such as an Allen key, of larger diameter can be inserted into hole 38 of stop element 40 to unscrew stop element 40 from opening 20 and separate stop element 40 and bolt 30 from crank 16, 16a.

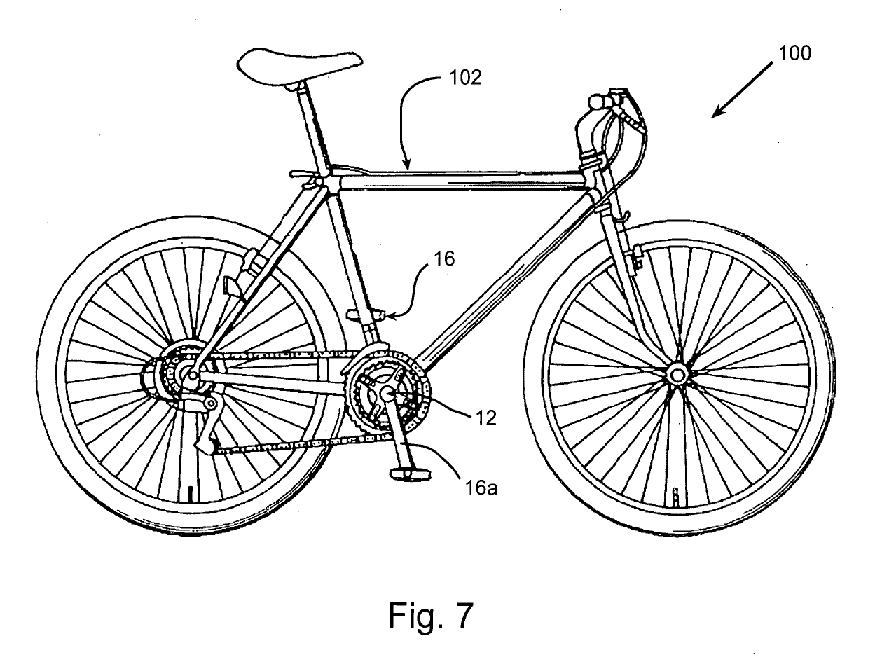

FIG. 7 shows a bicycle 100 comprising a bicycle frame 102 on which is mounted a crank assembly of the present invention.

Although the invention has been explained in relation to its preferred embodiment, it is to be understood that many other possible modifications and variations can be made without departing from the spirit and scope of the invention as hereafter claimed.

1. Crank assembly comprising: an axle, said axle comprising at least at one end thereof an engagement section, said engagement section comprising a central bore with a first inner threaded section, said assembly further comprising a crank arm with an opening, where said engagement section is at least partially received in said opening, said assembly further comprising a bolt with a first outer threaded section, said bolt being engaged with said first inner threaded section of said engaged section, said bolt further comprising a first tool-engaging hole, said assembly further comprising a stop element inserted in said opening, said stop element comprising a second outer threaded section and a second tool-engaging hole, where said opening comprises an second inner threaded section engaged with said second outer threaded section, and where said second tool engaging hole has a diameter larger than said first tool-engaging hole, and where said first tool-engaging hole is accessible from an axial direction through said second tool-engaging hole.

2. Crank assembly according to claim 1, where said first and second tool-engaging holes are shaped as multi-sided holes of hexagonal cross-section.

3. Crank assembly according to claim 1, where said bolt comprises a first and second end, where said first end is configured as a flange.

4. Crank assembly according to claim 3, where said stop element comprises a recess, in which said flange is at least partially received.

5. Crank assembly according to claim 1, where said stop element has the shape of a disc.

6. Crank assembly according to claim 1, where a friction-reducing separation element is provided between said bolt and said stop element.

7. Crank assembly according to claim 1, where said opening comprises a connection section, said connection section comprising a number of longitudinal webs defining grooves between them on the inside.

8. Crank assembly according to claim 7, where at the end of said connection section the ends of the webs form upper edges, said assembly further comprising a washer element received in said opening and abutting against said edges.

9. Crank arm assembly comprising a crank arm, said crank arm comprising an opening for fixing an axle thereto, a bolt which can be inserted into said opening, said bolt comprising a first outer threaded section and a first tool-engaging hole, a stop element comprising a second outer threaded section and a second tool-engaging hole, where said opening comprises a second inner threaded section engageable with said second outer threaded section, and where said second tool-engaging hole has a diameter larger than said first tool-engaging hole, and where said first tool-engaging hole is accessible from an axial direction through said second tool-engaging hole.

10. Method for dismounting a crank arm from an axle, including the steps of
a. providing a crank assembly comprising an axle, said axle comprising at both ends thereof an engagement section, said engagement section comprising a central bore with a first inner threaded section, said assembly further comprising a crank arm with an opening, where said engagement section is at least partially received in said opening, said assembly further comprising a bolt with a first outer threaded section, said bolt being engaged with said first inner threaded section, said bolt further comprising a first tool-engaging hole, said assembly further comprising a stop element inserted in said opening, said stop element comprising a second outer threaded section and a second tool-engaging hole, where said opening comprises a second inner threaded section engaged with said second outer threaded section, and where said second tool-engaging hole has a diameter larger than said first tool-engaging hole, and where said first tool-engaging hole is accessible from an axial direction through said second tool-engaging hole;
b. inserting a first tool of a first diameter through the second tool-engaging hole into the first tool-engaging hole;
c. turning said first tool to unscrew said bolt from said engagement section, thereby pushing said engagement section out of said opening in an axial direction;
d. extracting said first tool from said first and second tool-engaging hole.

11. Method for dismounting a crank arm from an axle, including the steps of
a. providing a crank assembly comprising an axle, said axle comprising at both ends thereof an engagement section, said engagement section comprising a central bore with a first inner threaded section, said assembly further comprising a crank arm with an opening, where said engagement section is at least partially received in said opening, said assembly further comprising a bolt with a first outer threaded section, said bolt being engaged with said first inner threaded section, said bolt further comprising a first tool-engaging hole, said assembly further comprising a stop element inserted in said opening, said stop element comprising a second outer threaded section and a second tool-engaging hole, where said opening comprises a second inner threaded section engaged with said second outer threaded section, and where said second tool-engaging hole has a diameter larger than said first tool-engaging hole, and where said first tool-engaging hole is accessible from an axial direction through said second tool-engaging hole;
b. inserting a first tool of a first diameter through the second tool-engaging hole into the first tool-engaging hole;
c. turning said first tool to unscrew said bolt from said engagement section, thereby pushing said engagement section out of said opening in an axial direction;
d. extracting said first tool from said first and second tool-engaging hole;
e. inserting a second tool of a second diameter into the second tool-engaging hole, said second diameter being larger than said first diameter, and turning said second tool to unscrew said stop element from said opening.
